(19) United States
(12) Patent Application Publication
(10) Pub. No.: US 2021/0352978 A1
(43) Pub. Date: Nov. 18, 2021

(54) RESPIRATORY MASK DEVICE

(71) Applicants: Gottardo Cavero, Chicago, IL (US); Alejandro Valencia Hernandez, Miami, FL (US)

(72) Inventors: Gottardo Cavero, Chicago, IL (US); Alejandro Valencia Hernandez, Miami, FL (US)

(21) Appl. No.: 17/321,419

(22) Filed: May 15, 2021

Related U.S. Application Data
(60) Provisional application No. 63/026,055, filed on May 17, 2020.

(51) Int. Cl. A41D 13/11; A62B 23/02

(52) U.S. Cl. CPC A41D 13/113; A41D 13/1161; A62B 23/025

(57) ABSTRACT

A respiratory mask device may include a body having an interior surface, an exterior surface, and an interior surface perimeter. The body may comprise a planar filtering material which is able to allow air to pass through while blocking aerosol particles, and the body may comprise a cavity formed by the interior surface of the body that is shaped and sized to receive at least the mouth and nose of the user. When the device is worn by a user, the interior surface may be positioned proximate to the mouth and nose of the user, and the interior surface perimeter may be configured to encircle at least the mouth and nose of the user. A facial adhesive material may be disposed along a portion of the interior surface perimeter so that the facial adhesive material may removably couple the device to the face of the user.

### CROSS REFERENCE TO RELATED APPLICATIONS

This application claims priority to and the benefit of the filing date of U.S. Provisional Application No. 63/026,055, filed on May 17, 2020, entitled “RESPIRATORY MASK DEVICE”, which is hereby incorporated by reference in its entirety.

### FIELD OF THE INVENTION

This patent specification relates to the field of respiration filtering masks. More specifically, this patent specification relates to a respiratory mask device that does not require straps for wrapping around the ears or head of a user.

### BACKGROUND

Respiration filtering masks are worn over the mouth and nose of a user and are used to filter aerosols, such as dust, expired water droplets, viruses, bacteria, and other pathogens, from the air entering and/or exiting the mask. In some scenarios they are worn as a preference, while in other scenarios they are worn as a necessity. Existing masks typically employ one or more straps which are used to secure and position the mask on the head of the wearer. These straps may include an ear strap which may wrap around one or both ears of the wearer and head straps which may wrap around other portions of the head of the wearer. However, these masks can become a hinderance when the user is in a situation in which their ears, neck, hair, etc., may need to be free, such as when the user is getting a hair cut or treatment, when the user is receiving a head massage, when the head of the user is being examined or undergoing a medical procedure, and the like. In situations such as these, at best, these existing masks are inconvenient as the straps must be repositioned, and at worst, these existing masks can fail to serve their purpose as repositioning of the straps may allow aerosols to enter and/or exist the mask thereby jeopardizing the health of the user and nearby individuals. Furthermore, the straps of masks frequently become entangled with earrings which is not only uncomfortable but can also result in injury if not carefully removed.

Therefore, a need exists for novel respiration filtering masks. A further need exists for novel respiration filtering masks which are able to be worn without straps that cover other portions of the head of the user.

### BRIEF SUMMARY OF THE INVENTION

A respiratory mask device is provided. In some embodiments, the device may include a body having an interior surface, an exterior surface, and an interior surface perimeter. The body may comprise a planar filtering material which is able to allow air to pass through while blocking aerosol particles, and the body may comprise a cavity formed by the interior surface of the body that is shaped and sized to receive at least the mouth and nose of the user. When the device is worn by a user, the interior surface may be positioned proximate to the mouth and nose of the user, and the interior surface perimeter may be configured to encircle at least the mouth and nose of the user. A facial adhesive material may be disposed along a portion of the interior surface perimeter so that the facial adhesive material may removably couple the device to the face of the user.

In further embodiments, the device may include a body having an interior surface perimeter and a cavity. The interior surface perimeter may be shaped and sized to encircle the mouth and nose of a user, and the cavity may be shaped and sized to receive and cover the mouth and nose of the user. A facial adhesive surface may be coupled to or proximate to the interior surface perimeter so that the facial adhesive surface may removably couple the device over the mouth and nose of a user. The body may comprise a planar filtering material which is able to allow air to pass through while blocking aerosol particles. A block filtering material may be coupled to the body so that the block filtering material may be positioned at or below the chin of a user wearing the device. The device may include one or more fold lines which may allow the body and block filtering material to be folded to be reduced in size and increased in size to allow the device to be worn.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts a front perspective view of an example of a respiratory mask device in a folded state and expanded conformation being worn by a user according to various embodiments described herein.

FIG. 2 illustrates a side perspective view of an example of a respiratory mask device in a folded state and expanded conformation being worn by a user according to various embodiments described herein.

FIG. 3 shows a rear perspective view of an example of a respiratory mask device, having a liner, in a folded state and expanded conformation according to various embodiments described herein.

FIG. 4 depicts the example of a respiratory mask device of FIG. 3 having the liner removed according to various embodiments described herein.

FIG. 5 illustrates a first side elevation view of an example of a respiratory mask device in a folded state and a compact conformation according to various embodiments described herein.

FIG. 6 shows a bottom plan view of an example of a respiratory mask device in a folded state and a compact conformation according to various embodiments described herein

FIG. 7 depicts a rear perspective view of an example of a respiratory mask device, having a release liner, in an unfolded state according to various embodiments described herein.

FIG. 8 illustrates a rear elevation view of the example respiratory mask device of FIG. 7, having the release liner removed, in an unfolded state according to various embodiments described herein.

FIG. 9 shows a top plan view of the example respiratory mask device of FIG. 8, having the release liner removed, in an unfolded state according to various embodiments described herein.

FIG. 10 depicts a front perspective view of another example of a respiratory mask device according to various embodiments described herein.

FIG. 11 illustrates a rear perspective view of the example respiratory mask device of FIG. 10 according to various embodiments described herein.

FIG. 12 shows a side perspective view of the example respiratory mask device of FIGS. 10 and 11 according to various embodiments described herein.

FIG. 13 depicts a sectional, elevation view of an example of a respiratory mask device being worn by an individual according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

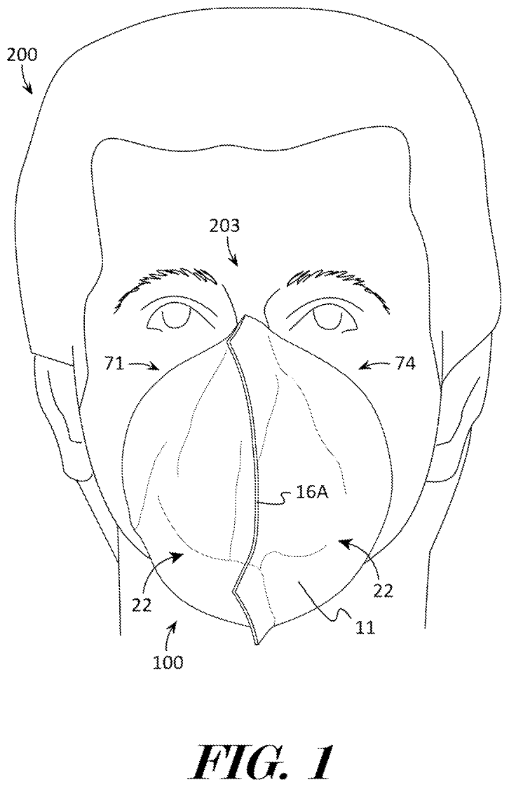

For purposes of description herein, the terms “upper”, “lower”, “left”, “right”, “rear”, “front”, “side”, “vertical”, “horizontal”, and derivatives thereof shall relate to the invention as oriented in FIG. 1. However, one will understand that the invention may assume various alternative orientations and step sequences, except where expressly specified to the contrary. Therefore, the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Although the terms “first”, “second”, etc. are used herein to describe various elements, these elements should not be limited by these terms. These terms are only used to distinguish one element from another element. For example, the first element may be designated as the second element, and the second element may be likewise designated as the first element without departing from the scope of the invention.

As used in this application, the term “about” or “approximately” refers to a range of values within plus or minus 10% of the specified number. Additionally, as used in this application, the term “substantially” means that the actual value is within about 10% of the actual desired value, particularly within about 5% of the actual desired value and especially within about 1% of the actual desired value of any variable, element or limit set forth herein.

A new respiratory mask device is discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

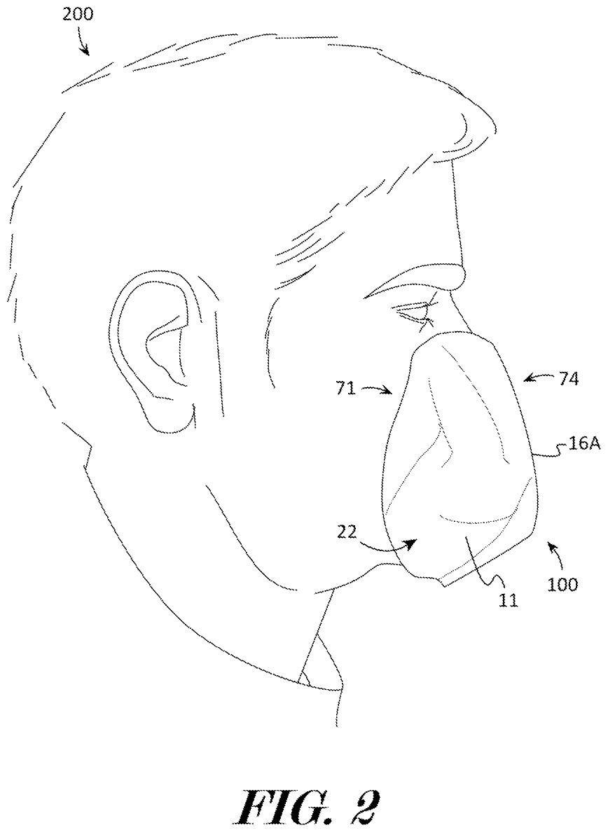

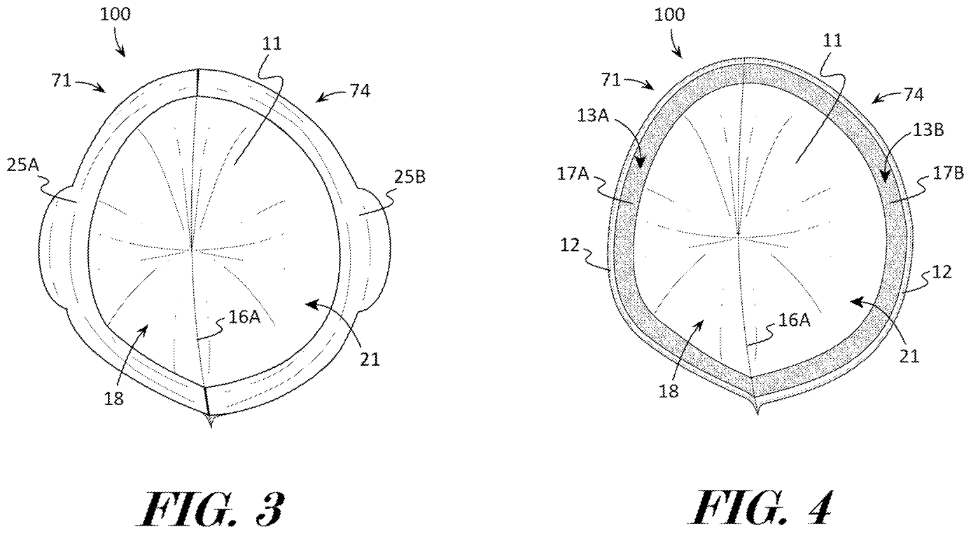

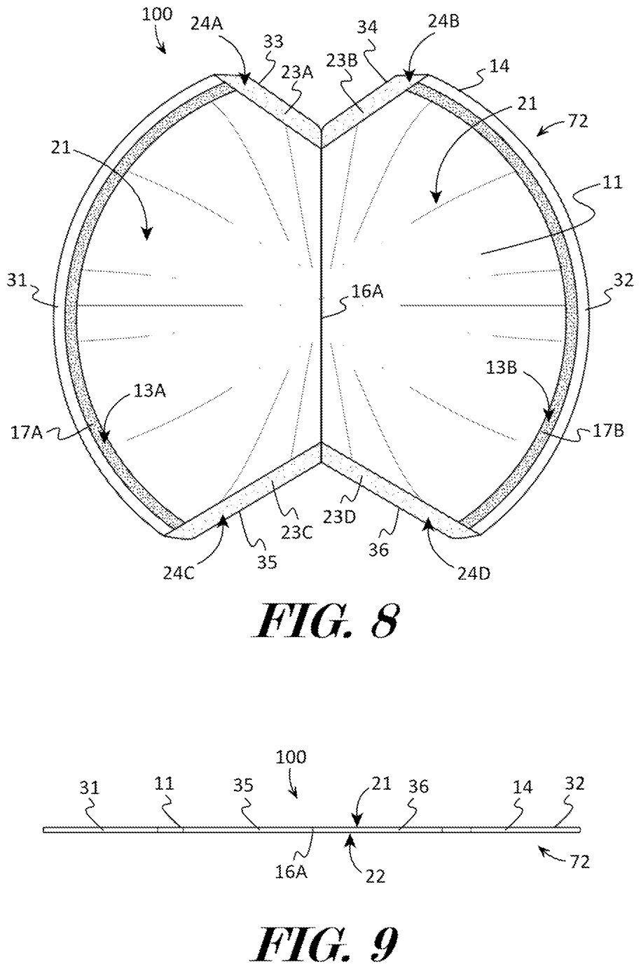

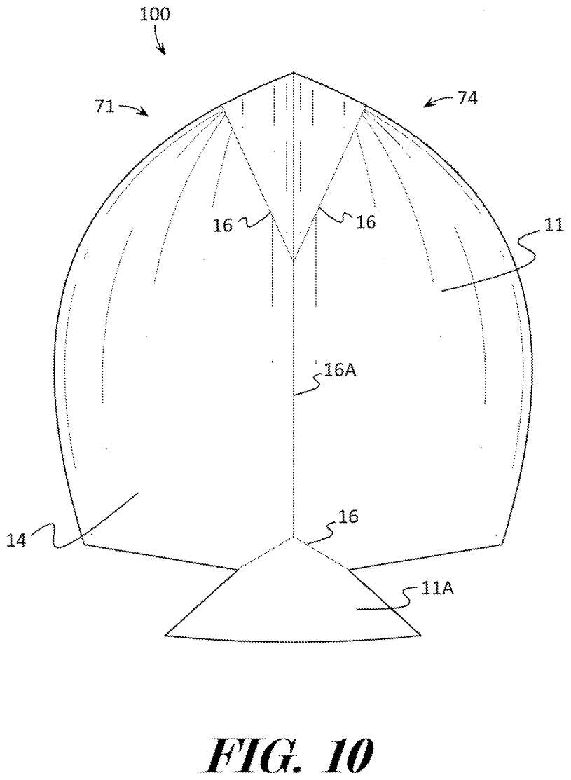

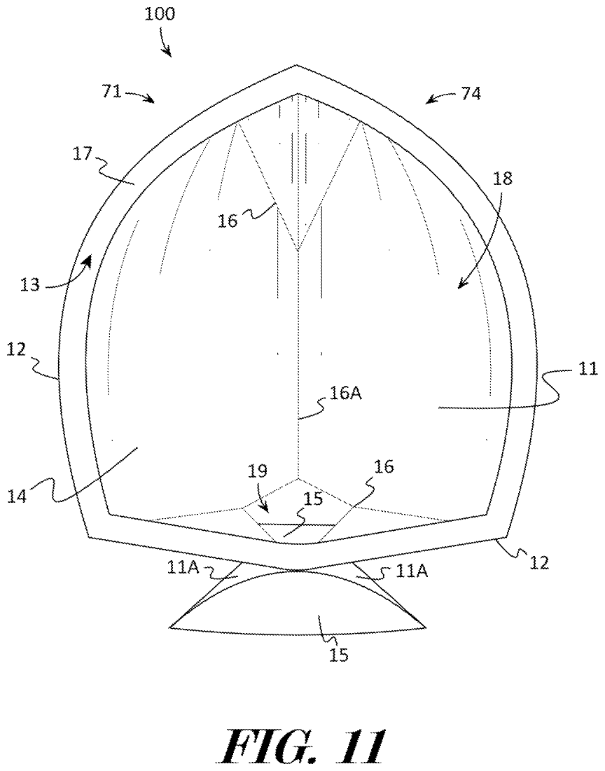

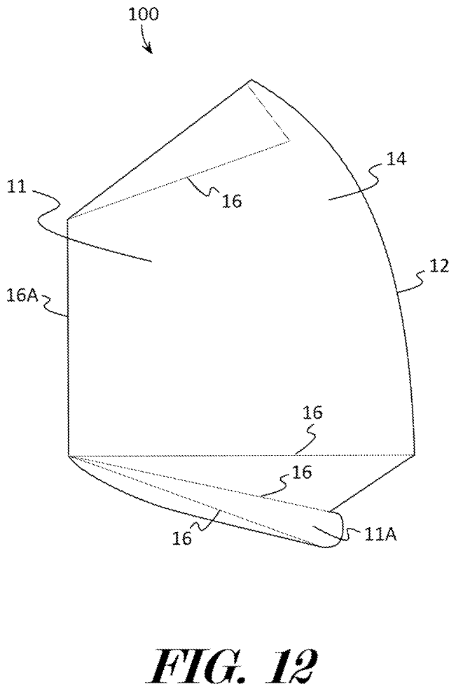

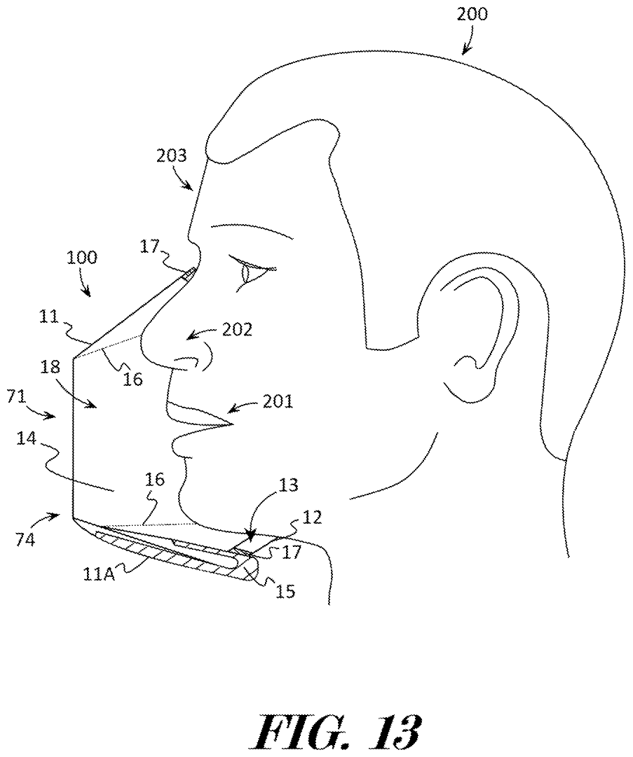

The present invention will now be described by example and through referencing the appended figures representing preferred and alternative embodiments. FIGS. 1-13 illustrate examples of a respiratory mask device (“the device”) 100 according to various embodiments. In some embodiments, the device 100 may comprise a body 11 having an interior surface 21, an exterior surface 22, and an interior surface perimeter 12. The body 11 may comprise a planar filtering material 14 which is able to allow air to pass through while blocking aerosol particles, and the body 11 may comprise a cavity 18 formed by the interior surface 21 of body 11 that is shaped and sized to receive at least the mouth 201 and nose 202 of the user 200. When the device 100 is worn by a user 200, the interior surface 21 may be positioned proximate to the mouth 201 and nose 202 of the user 200, and the interior surface perimeter 12 may be configured to encircle at least the mouth 201 and nose 202 of the user 200. A facial adhesive material 17 may be disposed along a portion of the interior surface perimeter 12 so that the facial adhesive material 17 may removably couple the device 100 to the face 203 of the user 200.

The device 100 may comprise a body 11 which may be sized and shaped to allow the body 11 to cover or encircle the mouth and nose of a user 200 when the device 100 is worn by the user 200. The body 11 may include a cavity 18 which may be sized and shaped so that when the device 100 is secured to the face 203 of a user 200, the nose 202 and mouth 201 of the user 200 may be positioned in the cavity 18 while the interior surface perimeter 12 encircles the mouth 201 and nose 202 of the user 200.

In preferred embodiments, the body 11 may comprise a section of a generally ovoid shape so as to have a generally ovoid shaped cavity 18. In further embodiments, the body 11 may comprise a section of a generally spheroid shape so as to have a generally ovoid spheroid shaped cavity 18. In further embodiments, the body 11 may comprise a section of a generally triangular prism shape, rectangular prism shape, hexagonal prism shape, or any other shape, including combinations of shapes and the cavity 18 may likewise comprise any other shape including combinations of shapes. It should be noted that the shape of the cavity 18 is not dependent on the shape of the body 11.

A body 11 may comprise or be made from any material which may be suitable for contacting a user 200. In preferred embodiments, the body 11 may comprise a planar filtering material 14 that may be configured as a generally thin sheet of material which may be bent, folded, or otherwise shaped to form the shape and contours of the body 11. In further preferred embodiments, a body 11 may be made from or may comprise a planar filtering material 14 which is able to allow air to pass through while blocking aerosol particles that may be greater than approximately 1 micron in size. For example, a planar filtering material 14 may comprise a material that may be used as a MERV-13 (Minimum Efficiency Reporting Value) or greater class filter. As another example, a planar filtering material 14 may comprise a material that may be used in particulate respirators, such as N95 masks that filter particles as small as 1 micron. As another example, a planar filtering material 14 may comprise a material such as pleaded paper, airlaid paper, such as the type use on surgical disposable masks, or any other paper based air filtering material.

In further embodiments, a planar filtering material 14 may comprise a mesh of synthetic polymer fibers, also known as nonwoven polypropylene fabric, which may be produced through a process called melt blowing that forms a filtration layer for filtering out aerosols or hazardous particles. In further embodiments, a planar filtering material 14 may comprise mat(s) of nonwoven fibrous materials, such as wool felt, melt blown, Stapled Nonwoven, Spunlaid Nonwovens, Flashspun or polypropylene and resin with a BFE/VFE>95%. In still further embodiments, a planar filtering material 14 may comprise any material that filters airborne particles, pollutants, bacteria and/or viruses and that can be used for these purposes.

The body 11 may comprise an interior surface perimeter 12 which may form the portions of the body 11 which may be closest to the portions of the face 203 of the user 200 when the device 100 is worn by the user 200. Generally, the interior surface perimeter 12 may form the boundary of the cavity 18. Optionally, one or more portions of an interior surface perimeter 12 may contact portions of the face 203 of the user 200 when the device 100 is worn by the user 200. In preferred embodiments, an interior surface perimeter 12 may comprise a closed curve in a plane shape, such as a generally oval shape or circular shape. In further embodiments, an interior surface perimeter 12 may comprise a generally triangular shape, a generally rectangular shape, a generally hexagonal shape, or any other shape, including combinations of shapes.

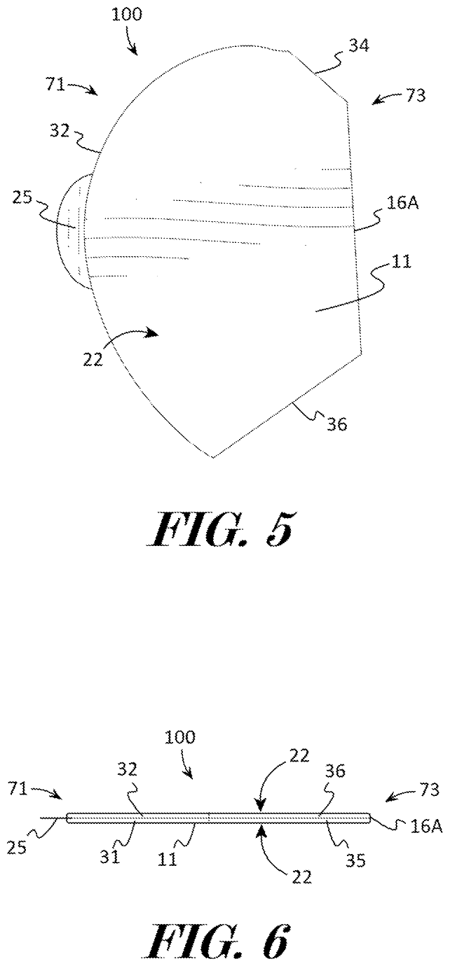

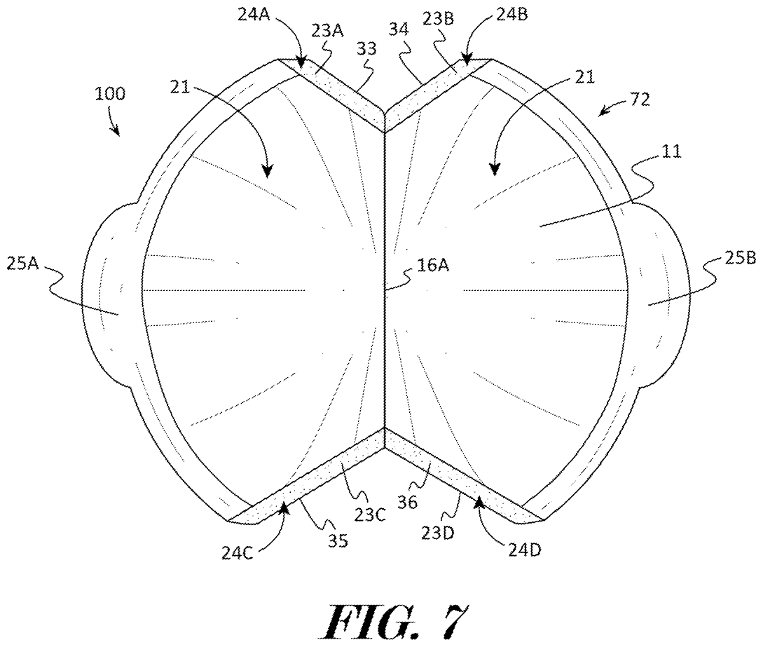

In preferred embodiments, the device 100 may comprise a body 11 which may be formed from a planar filtering material 14 that comprises a sheet of material (as perhaps best shown in FIGS. 7-9) which may be cut and folded to allow the device 100 to assume a 3D shape (as perhaps best shown in FIGS. 1-4 and 10-13). FIGS. 7-9 depict the device 100 in an unfolded state 72 showing how the body 11 may be formed from a planar filtering material 14 that comprises a sheet of material. FIGS. 5 and 6 depict the device 100 in a folded state 71 in which the upper joining edges 33, 34, have been coupled together and the lower joining edges 35, 36, have also been coupled together and the body 11 is folded flat so that the body 11 is generally folded in half along a central fold line 16A and so that the cavity 18 is generally inaccessible. It should be noted that FIGS. 5 and 6 depict the device 100 in a compact conformation 73 in which the body 11 is folded flat so that the body 11 is generally folded in half along a central fold line 16A and so that the cavity 18 is generally inaccessible. FIGS. 1-4 and 10-13 depict the device in a folded state 71 and also in an expanded conformation 74 in which the body 11 is folded along a central fold line 16A and in which the cavity 18 is accessible so that at least the nose 202 and mouth 201 of a user 200 may be received in the cavity 18.

In some embodiments, the body 11 may comprise a first interior perimeter edge 31 and a second interior perimeter edge 32 that are positioned on opposing sides of a central fold line 16. Preferably, in order to form the interior surface perimeter 12, the body 11 may be folded in order to bring the first interior perimeter edge 31 and second interior perimeter edge 32 into contact with each other so that the interior perimeter edge 31 and second interior perimeter edge 32 may form the interior surface perimeter 12.

In some embodiments, the body 11 may comprise a first upper joining edge 33 and a second upper joining edge 34. A first upper joining edge 33 may extend from a central fold line 16A to an upper portion (positioned closer to nose of user when device 100 is worn) of a first interior perimeter edge 31, and a second upper joining edge 34 may also extend from the central fold line 16A to an upper portion (positioned closer to nose 202 of user 200 when device 100 is worn) of a second interior perimeter edge 32. Preferably, first upper joining edge 33 and a second upper joining edge 34 may meet at a central fold line 16A. In further embodiments, the body 11 may comprise a first lower joining edge 35 and a second lower joining edge 36 which may be opposingly positioned to the upper joining edges 33, 34. A first lower joining edge 35 may extend from a central fold line 16A to a lower portion (positioned closer to chin of user 200 when device 100 is worn) of a first interior perimeter edge 31, and a second lower joining edge 36 may also extend from the central fold line 16A to a lower portion (positioned closer to chin of user 200 when device 100 is worn) of a second interior perimeter edge 32. Preferably, first lower joining edge 35 and a second lower joining edge 36 may meet at a central fold line 16A.

In preferred embodiments, one or more joining edges 33, 34, 35, 36, may comprise a linear shape. In other embodiments, one or more joining edges 33, 34, 35, 36, may comprise a curved shape, and/or be configured with any shape and size. Generally, the upper joining edges 33, 34, may be coupled together via a body adhesive material 23A, 23B, and the lower joining edges 35, 64, may also be coupled together via a body adhesive material 23C, 23D, which may enable the device 100 to assume a 3-dimensional (3D) shape thereby allowing a body 11 that comprises a planar filtering material 14 to form a cavity 18. Body adhesive material 23A, 23B, 23C, 23D, applied to an element of the body 11 may form a body adhesive surface 24A, 24B, 24C, 24D, and a body adhesive surface 24A, 24B, 24C, 24D, may be used to adhere or couple the body adhesive surface 24A, 24B, 24C, 24D, to another body adhesive surface 24A, 24B, 24C, 24D, or to any other portion of the body 11 that the body adhesive surface 24A, 24B, 24C, 24D, may be placed in contact with.

In some embodiments, a first body adhesive material 23A, 23B, may be applied or disposed along the first upper joining edge 33 and/or along the second upper joining edge 34, and the upper joining edges 33, 34, may be coupled together via the first body adhesive material 23A on the first upper joining edge 33 and/or via the first body adhesive material 23B on the second upper joining edge 34. In some embodiments, a second body adhesive material 23C, 23D, may be applied or disposed along the first lower joining edge 35 and/or along the second lower joining edge 36, and the lower joining edges 35, 36, may be coupled together via the second body adhesive material 23C on the first lower joining edge 35 and/or via the second body adhesive material 23D on the second lower joining edge 36.

Body adhesive material 23A, 23B, 23C, 23D, may comprise any adhesive material which may be suitable for being placed proximate to a user's face. In preferred embodiments, a body adhesive material 23A, 23B, 23C, 23D, may comprise an acrylic water-based medical grade adhesive, a hot melt medical grade adhesive, or any other suitable medical grade type of adhesive, including hypo allergenic type of adhesive, or any other suitable type of adhesive that is safe for skin contact. In further embodiments, a body adhesive material 23A, 23B, 23C, 23D, may comprise or be made of medical grade adhesive materials that have been approved for direct contact with human skin and are suitable to be applied and removed without damaging the skin. Adhesives may include but are not limited to natural adhesives including natural resins, bioadhesives, or synthetic adhesives such as epoxy, polyurethane, acrylate, including methacrylates and epoxy diacrylates (which are also known as vinyl resins), cyanoacrylate and acrylic polymer-based adhesives. While the term adhesive is used, it should be understood that this term may at times be substituted for glues, cements, mucilages, or pastes.

In preferred embodiments, the body 11 may comprise: a first interior perimeter edge 31 and a second interior perimeter edge 32 that are positioned on opposing sides of a central fold line 16A; and a first upper joining edge 33 and a second upper joining edge 34, in which the first upper joining edge 33 and the second upper joining edge 34 may be coupled together via at least one body adhesive material 23A, 23B, to bring a first portion (upper portion) of the first interior perimeter edge 31 and a first portion (upper portion) of the second interior perimeter edge 32 into contact with each other. In further preferred embodiments, the body 11 may comprise: a first interior perimeter edge 31 and a second interior perimeter edge 32 that are positioned on opposing sides of a central fold line 16A; and a first lower joining edge 35 and a second lower joining edge 36, in which the first lower joining edge 35 and the second lower joining edge 36 may be coupled together via at least one body adhesive material 23C, 23D, to bring a second portion (lower portion) of the first interior perimeter edge 31 and a second portion (lower portion) of the second interior perimeter edge 32 into contact with each other.

In preferred embodiments, the device 100 may comprise one or more facial adhesive surfaces 13, 13A, 13B, which may be coupled to or proximate to the interior surface perimeter 12 so that the facial adhesive surfaces 13, 13A, 13B, may removably couple the device 100 over the mouth and nose of a user 200. A facial adhesive surface 13, 13A, 13B, may be formed by a facial adhesive material 17, 17A, 17B, which may be coupled to all or portions of the interior surface perimeter 12. A facial adhesive surface 13, 13A, 13B, may be configured in any shape and size. Optionally, the device 100 may include two or more facial adhesive surfaces 13, 13A, 13B, such as a plurality of facial adhesive surfaces 13. For example, the device 100 may comprise a first facial adhesive material 17A disposed along a first interior perimeter edge 31 and a second facial adhesive material 17B disposed along a second interior perimeter edge 32 with the first facial adhesive material 17A forming a first facial adhesive surface 13A and the second facial adhesive material 17B forming a second facial adhesive surface 13B.

In some embodiments, the device 100 may comprise a first interior perimeter edge 31 and a second interior perimeter edge 32 which may form the interior surface perimeter 12 when the upper joining edges 33, 34, are coupled together and when the lower joining edges 35, 36, are coupled together. In some embodiments, a first portion of the facial adhesive material 17A may be disposed along the first interior perimeter edge 31 between the first upper joining edge 33 and the first lower joining edge 35. In further embodiments, a second portion of the facial adhesive material 17B may be is disposed along the second interior perimeter edge 32 between the second upper joining edge 34 and the second lower joining edge 36.

In preferred embodiments, a first portion of the facial adhesive material 17A may be disposed along substantially the entirely of the first interior perimeter edge 31 between the first upper joining edge 33 and the first lower joining edge 35. In further preferred embodiments, a second portion of the facial adhesive material 17B may be is disposed substantially the entirely of the second interior perimeter edge 32 between the second upper joining edge 34 and the second lower joining edge 36. By having the first portion of the facial adhesive material 17A may be disposed along substantially the entirely of the first interior perimeter edge 31 between the first upper joining edge 33 and the first lower joining edge 35, and by having the second portion of the facial adhesive material 17B may be is disposed substantially the entirely of the second interior perimeter edge 32 between the second upper joining edge 34 and the second lower joining edge 36, the facial adhesive material 17A, 17B, may be disposed along substantially the entirety of the interior surface perimeter 12 so that the facial adhesive material 17A, 17B, encircles the mouth 201 and nose 202 of the user 200 when the device 100 is worn by the user 200.

In some embodiments, a facial adhesive material 17, 17A, 17B, may comprise an acrylic water-based medical grade adhesive, a hot melt medical grade adhesive, or any other suitable medical grade type of adhesive, including hypo allergenic type of adhesive, or any other suitable type of adhesive that is safe for skin contact. In further embodiments, a facial adhesive material 17, 17A, 17B, may comprise or be made of medical grade adhesive materials that have been approved for direct contact with human skin and are suitable to be applied and removed without damaging the skin. Adhesives may include but are not limited to natural adhesives including natural resins, bioadhesives, or synthetic adhesives such as epoxy, polyurethane, acrylate, including methacrylates and epoxy diacrylates (which are also known as vinyl resins), cyanoacrylate and acrylic polymer-based adhesives. While the term adhesive is used, it should be understood that this term may at times be substituted for glues, cements, mucilages, or pastes.

In some embodiments, the device 100 may comprise one or more release liners 25 which may be removably coupled to one or more adhesive surfaces 13, 13A, 13B, 24A, 24B, 24C, 24D. A release liner 25 may be adhered to one or more adhesive surfaces 13, 13A, 13B, 24A, 24B, 24C, 24D, and may be configured to be peeled away or otherwise release from the one or more adhesive surfaces 13, 13A, 13B, 24A, 24B, 24C, 24D, allowing the one or more adhesive surfaces 13, 13A, 13B, 24A, 24B, 24C, 24D, to adhere to another material or surface. A release liner 25 may comprise a paper or plastic-based film sheet used to prevent an adhesive material 17, 17A, 17B, 23A, 23B, 23C, 23D, from prematurely adhering. It may be coated on one or both sides with a release agent, such as crosslinkable silicone, which provides a release effect against any type of a sticky material such as an adhesive or a mastic. In preferred embodiments, the device 100 may comprise a first release liner 25A which may be removably coupled to a first facial adhesive surface 13A and a second release liner 25B which may be removably coupled to a second facial adhesive surface 13B. The release liner(s) 25A, 25B, may allow the device 100 to be in a folded state 71 and compact conformation 73 (FIGS. 5 and 6) while preventing the facial adhesive surfaces 13A, 13B, from contacting each other or other objects until the user 200 is ready to peel the release liner(s) 25A, 25B, away and apply the device 100 to their face.

In some embodiments, the device 100 may comprise a body 11 having an interior surface perimeter 12 which may be shaped and sized to encircle the mouth and nose of a user 200. A facial adhesive surface 13 may be coupled to or proximate to the interior surface perimeter 12 so that the facial adhesive surface 13 may removably couple the device 100 over the mouth 201 and nose 202 of a user 200. The body 11 may comprise a planar filtering material 14 which is able to allow air to pass through while blocking aerosol particles. A block filtering material 15 may be coupled to the body 11 so that the block filtering material 15 may be positioned at or below the chin of a user 200 wearing the device 100. The device 100 may include one or more fold lines 16 which may allow the body 11 and block filtering material 15 to be folded to be reduced in size and to be unfolded to be increased in size to allow the device 100 to be worn.

The device 100 may comprise a block filtering material 15 which may be coupled to the body 11, such as to a block filtering panel 11A, so that the block filtering material 15 may be positioned at or below the chin of a user 200 wearing the device 100. A block filtering panel 11A may comprise any shape and size, and the block filtering panel 11A may provide a bonding surface on the body 11 that a block filtering material 15 may be coupled to.

In preferred embodiments, the body 11 may be formed of a single piece of planar filtering material 14 that may be folded into a 3D shape to form the cavity 18 and a block filtering material 15 may be coupled to the body 11 so that air from the cavity 18 may also exit the cavity 18 through the block filtering material 15. In further preferred embodiments, the device 100 may comprise a filter aperture 19 which may be formed by the planar filtering material 14 and which may enable air to easily pass through the block filtering material 15 from or to the cavity 18.

In preferred embodiments, a block filtering material 15 may be configured to be relatively thicker or bulkier than the material which may be used to form the planar filtering material 14. In further preferred embodiments, a block filtering material 15 may be made from a material which is able to allow air to pass through while blocking aerosol particles that may be greater than approximately 1 to 3 microns in size. For example, a block filtering material 15 may comprise a material that may be used as a MERV-9 (Minimum Efficiency Reporting Value) or greater class filter. As another example, a block filtering material 15 may comprise a material that may be used in particulate respirators, such as N95 masks one or more-fold that filter particles as small as 1 micron. In further embodiments, a block filtering material 15 may comprise a mesh of synthetic polymer fibers, also known as nonwoven polypropylene fabric, which may be produced through a process called melt blowing that forms a filtration layer for filtering out aerosols or hazardous particles. In further embodiments, a block filtering material 15 may comprise mat(s) of nonwoven fibrous materials, such as wool felt, or polypropylene, melt blown, Stapled Nonwoven, Spunlaid Nonwovens, Flashspun or polypropylene and resin with a BFE/VFE>95%. In still further embodiments, a block filtering material 15 may be made from a material which is able to allow air to pass through while blocking aerosol particles that may be greater than approximately 1 micron in size. In still further embodiments, a block filtering material 15 may comprise any suitable material that filters airborne particles, pollutants, bacteria and/or viruses and that can be used for these purposes.

In some embodiments, the device 100 may comprise one or more fold lines 16, such as a first fold line 16, a second fold line 16, a third fold line 16, central fold line 16A, etc. Preferably, the body 11 may be made from a single or continuous piece of planar filtering material 14, and one or more fold lines 16 may be formed into the planar filtering material 14 to form the cavity 18 and to allow the device 100 to be folded to be reduced in size and to be unfolded to be increased in size to allow the device 100 to be worn. Generally, a fold line 16 may comprise a so-called “living” hinge, which typically comprises a linear, relatively flexible area between two relatively more rigid components, such as a line of thin plastic or flexible metal between thicker or more rigid portions, as is well known in the art. By utilizing one or more fold lines 16, the mask shape of the device 100 may be accomplished with a single piece of material (having no glued parts or other coupling methods) forming the body 11 so as to avoid air leakages through coupled body 11 areas due to malfunctions or errors in manufacturing. The fold lines 16 enables the body 11 and optionally other elements of the device 100, such as a block filtering material 15, to be folding or collapsible so as to help make the mask easy to store and for transport.

While some exemplary shapes and sizes have been provided for elements of the device 100, it should be understood to one of ordinary skill in the art that the body 11, block filtering material 15, fold lines 16, adhesive material 17, and any other element described herein may be configured in a plurality of sizes and shapes including “T” shaped, “X” shaped, square shaped, rectangular shaped, cylinder shaped, cuboid shaped, hexagonal prism shaped, triangular prism shaped, or any other geometric or non-geometric shape, including combinations of shapes. It is not intended herein to mention all the possible alternatives, equivalent forms or ramifications of the invention. It is understood that the terms and proposed shapes used herein are merely descriptive, rather than limiting, and that various changes, such as to size and shape, may be made without departing from the spirit or scope of the invention.

Additionally, while some materials have been provided, in other embodiments, the elements that comprise the device 100 may be made from or may comprise durable materials such as aluminum, steel, other metals and metal alloys, wood, hard rubbers, hard plastics, fiber reinforced plastics, carbon fiber, fiber glass, resins, polymers or any other suitable materials including combinations of materials. Additionally, one or more elements may be made from or may comprise durable and slightly flexible materials such as soft plastics, silicone, soft rubbers, or any other suitable materials including combinations of materials. In some embodiments, one or more of the elements that comprise the device 100 may be coupled or connected together with heat bonding, chemical bonding, adhesives, clasp type fasteners, clip type fasteners, rivet type fasteners, threaded type fasteners, other types of fasteners, or any other suitable joining method. In other embodiments, one or more of the elements that comprise the device 100 may be coupled or removably connected by being press fit or snap fit together, by one or more fasteners such as hook and loop type or Velcro® fasteners, magnetic type fasteners, threaded type fasteners, sealable tongue and groove fasteners, snap fasteners, clip type fasteners, clasp type fasteners, ratchet type fasteners, a push-to-lock type connection method, a turn-to-lock type connection method, a slide-to-lock type connection method or any other suitable temporary connection method as one reasonably skilled in the art could envision to serve the same function. In further embodiments, one or more of the elements that comprise the device 100 may be coupled by being one of connected to and integrally formed with another element of the device 100.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A respiratory mask device configured to be worn by a user having a face with a mouth and nose, the device comprising:
a body having an interior surface, an exterior surface, and an interior surface perimeter, wherein the body comprises a planar filtering material which is able to allow air to pass through while blocking aerosol particles, and wherein when the device is worn by a user, the interior surface is positioned proximate to the mouth and nose of the user and the interior surface perimeter is configured to encircle at least the mouth and nose of the user;
a cavity formed by the interior surface of the body that is shaped and sized to receive at least the mouth and nose of the user; and
a facial adhesive material disposed along a portion of the interior surface perimeter so that the facial adhesive material removably couples the device to the face of the user.

2. The device of claim 1, further comprising a release liner which is removably coupled to the facial adhesive material.

3. The device of claim 1, wherein the body is made of a planar filtering material which is able to allow air to pass through while blocking aerosol particles.

4. The device of claim 1, wherein the facial adhesive material is disposed along substantially an entirety of the interior surface perimeter so that the facial adhesive material encircles the mouth and nose of the user when the device is worn by the user.

5. The device of claim 1, wherein the body comprises a first interior perimeter edge and a second interior perimeter edge that are positioned on opposing sides of a central fold line, wherein the body comprises a first upper joining edge and a second upper joining edge, and wherein the first upper joining edge and the second upper joining edge are coupled together via a body adhesive material to bring a first portion of the first interior perimeter edge and a first portion of the second interior perimeter edge into contact with each other.

6. The device of claim 1, wherein the body comprises a first interior perimeter edge and a second interior perimeter edge that are positioned on opposing sides of a central fold line, wherein the body comprises a first lower joining edge and a second lower joining edge, and wherein the first lower joining edge and the second lower joining edge are coupled together via a body adhesive material to bring a second portion of the first interior perimeter edge and a second portion of the second interior perimeter edge into contact with each other.

7. The device of claim 1, wherein the body comprises a first interior perimeter edge and a second interior perimeter edge that are positioned on opposing sides of a central fold line, wherein the body comprises a first upper joining edge and a second upper joining edge, wherein the first upper joining edge and the second upper joining edge are coupled together via a first body adhesive material to bring a first portion of the first interior perimeter edge and a first portion of the second interior perimeter edge into contact with each other, and wherein the body comprises a first lower joining edge and a second lower joining edge, and wherein the first lower joining edge and the second lower joining edge are coupled together via a second body adhesive material to bring a second portion of the first interior perimeter edge and a second portion of the second interior perimeter edge into contact with each other

8. The device of claim 7, wherein a first portion of the facial adhesive material is disposed along the first interior perimeter edge between the first upper joining edge and the first lower joining edge.

9. The device of claim 7, wherein a second portion of the facial adhesive material is disposed along the second interior perimeter edge between the second upper joining edge and the second lower joining edge.

10. The device of claim 7, wherein the first body adhesive material is disposed along at least one upper joining edge selected from the group consisting of the first upper joining edge and the second upper joining edge.

11. The device of claim 7, wherein the second body adhesive material is disposed along at least one lower joining edge selected from the group consisting of the first lower joining edge and the second lower joining edge.

12. A respiratory mask device configured to be worn by a user, the device comprising:
a body having an interior surface, an exterior surface, and an interior surface perimeter, wherein the body comprises a planar filtering material which is able to allow air to pass through while blocking aerosol particles, and wherein when the device is worn by a user, the interior surface is positioned proximate to the mouth and nose of the user and the interior surface perimeter is configured to encircle at least the mouth and nose of the user;
a cavity formed by the interior surface of the body that is shaped and sized to receive at least the mouth and nose of the user;
a facial adhesive material disposed along a portion of the interior surface perimeter so that the facial adhesive material removably couples the device to the face of a user, wherein the facial adhesive material is disposed along substantially the entirety of the interior surface perimeter so that the facial adhesive material encircles the mouth and nose of the user when the device is worn by the user; and
a release liner which is removably coupled to the facial adhesive material.

13. The device of claim 12, wherein the body is made of a planar filtering material which is able to allow air to pass through while blocking aerosol particles.

14. The device of claim 12, wherein the body comprises a first interior perimeter edge and a second interior perimeter edge that are positioned on opposing sides of a central fold line, wherein the body comprises a first upper joining edge and a second upper joining edge, and wherein the first upper joining edge and the second upper joining edge are coupled together via a body adhesive material to bring a first portion of the first interior perimeter edge and second interior perimeter edge into contact with each other.

15. The device of claim 12, wherein the body comprises a first interior perimeter edge and a second interior perimeter edge that are positioned on opposing sides of a central fold line, wherein the body comprises a first lower joining edge and a second lower joining edge, and wherein the first lower joining edge and the second lower joining edge are coupled together via a body adhesive material to bring a second portion of the first interior perimeter edge and second interior perimeter edge into contact with each other.

16. The device of claim 12, wherein the body comprises a first interior perimeter edge and a second interior perimeter edge that are positioned on opposing sides of a central fold line, wherein the body comprises a first upper joining edge and a second upper joining edge, wherein the first upper joining edge and the second upper joining edge are coupled together via a first body adhesive material to bring a first portion of the first interior perimeter edge and second interior perimeter edge into contact with each other, and wherein the body comprises a first lower joining edge and a second lower joining edge, and wherein the first lower joining edge and the second lower joining edge are coupled together via a second body adhesive material to bring a second portion of the first interior perimeter edge and second interior perimeter edge into contact with each other

17. The device of claim 16, wherein a first portion of the facial adhesive material is disposed along the first interior perimeter edge between the first upper joining edge and the first lower joining edge.

18. The device of claim 16, wherein a second portion of the facial adhesive material is disposed along the second interior perimeter edge between the second upper joining edge and the second lower joining edge.

19. The device of claim 16, wherein the first body adhesive material is disposed along at least one upper joining edge selected from the group consisting of the first upper joining edge and the second upper joining edge.

20. The device of claim 16, wherein the second body adhesive material is disposed along at least one lower joining edge selected from the group consisting of the first lower joining edge and the second lower joining edge.
